(19) United States
(12) Patent Application Publication
(10) Pub. No.: US 2024/0271732 A1
(43) Pub. Date: Aug. 15, 2024

(54) ERROR-PROOF DOUBLE-LOCKING QUICK CONNECTOR

(71) Applicant: CHONGQING SULIAN PLASTICS CO.,LTD, Chongqing (CN)

(72) Inventors: MING XU, Baicheng (CN); SHULIN CAO, Chongqing (CN); XIONGWEI WAN, Chongqing (CN); TAIMING SHEN, Chongqing (CN); ZONGJUN HAN, Chongqing (CN); YI YANG, Chongqing (CN); XUYANG LI, Yibin (CN); ZIJING XU, Chongqing (CN)

(21) Appl. No.: 18/104,357

(22) PCT Filed: Nov. 25, 2021
(86) PCT No.: PCT/CN2021/133230

§ 371 Date: Feb. 1, 2023

(30) Foreign Application Priority Data
Jul. 5, 2021 (CN) 202110760122.0

(51) Int. Cl. F16L 37/14

(52) U.S. Cl. CPC F16L 37/144; F16L 2201/10

(57) ABSTRACT

The present application discloses an error-proof double-locking quick connector, comprising a male plug provided with a boss and a housing (1), a cavity structure is provided in the housing (1), and the cavity structure is provided with a first insertion hole (11), a second insertion hole (12), a first limiting hole (13) and a second limiting hole (14), and a positioning block (15) is also arranged in the cavity structure. A locking device is inserted into the first insertion hole (11), a positioning card is inserted into the second insertion hole (12). In the present application, a locker and a positioning card are connected and fixed on the housing, which has a double protection effect on the fixing of the male plug, and is also convenient for observing the installation state, avoiding the occurrence of installation falling off, the structure is simple, and it is easy to disassemble.

### CROSS-REFERENCE TO RELATED APPLICATIONS

The present application is a 35 U.S.C. § 371 National Phase conversion of International (PCT) Patent Application No. PCT/CN2021/133230 filed Nov. 25, 2021, which claims foreign priority of Chinese Patent Application No. 202110760122.0, filed on Jul. 5, 2021 in the State Intellectual Property Office of China, the contents of all of which are hereby incorporated by reference

### TECHNICAL FIELD

The present application relates to the field of automobile manufacturing, in particular to an error-proof double-locking quick connector.

### BACKGROUND

At present, the quick connection devices widely used in automotive fuel and new energy pipeline systems mainly use a single locking mechanism. Generally, the single locking mechanism connection device is unlocked by external force (vibration, flying stones, etc.) during the working process, resulting in a high risk of pipeline system leakage. Improving the single locking mechanism into a double locking mechanism can solve the above problems well. In the case that any one of the above-mentioned locking mechanisms is unlocked and fails, the other locking mechanism can still lock the male joint assembled and connected with it in the connecting device. Although a variety of double locking mechanism connection devices have been applied to automobile pipeline systems, there are still situations where the locking is unstable, especially after one of the locking mechanisms is easy to fall off from the connection device or fails during the unlocking process. The axial displacement of the male joint is relatively large, and there are also defects such as the inability to check whether the male joint is installed in place.

### SUMMARY

The technical problem to be solved in this application is to provide an error-proof double-locking quick connector that is convenient for disassembly and assembly, and convenient for checking the installation state of the male plug.

The technical solution of the application is as follows:

An error-proof double-locking quick connector, comprising a male plug with a boss and a housing (1), wherein a cavity structure is provided in the housing (1), and one end of the cavity structure is provided with a first insertion hole (11), the other end is provided with a second insertion hole (12), and a first limiting hole (13) and a second limiting hole (14) communicating with each other are symmetrically provided at the middle position of the corresponding cavity structure of the housing (1), the upper part of the same end hole wall of the two limiting holes is provided with a first inclined wall (17), a positioning block (15) is also provided in the cavity structure, and two first locking blocks (151) and two second locking blocks (152) are symmetrically arranged on the positioning block (15), the corresponding positions of the first locking block (151), the second locking block (152) and the positioning block (15) at the corresponding end form a clamping groove (161), the corresponding positions of the second locking block (152) and the positioning block (15) form an open groove (162), a locker is inserted into the first insertion hole (11), the locker comprises a pushing plate (21), and the upper end of the pushing plate (21) is provided with a limiting block (22), and the lower end is provided with a first clamping strip (23) and a second clamping strip (24), a second oblique section (25) is provided on each of the two clamping strips, and the corresponding positions of the two clamping strips are pre-engaged with the position of the clamping groove (161); a positioning card is inserted into the second insertion hole (12), and the positioning card comprises a first positioning rod (31) and a second positioning rod (32), each of the two positioning rods is provided with a first oblique section (33); after inserting the male plug, the boss moves from top to bottom and squeezes the first oblique section (33) and the second oblique section (25) sequentially, so that the two clamping strips and the two positioning rods are opened one after another, after the boss moves down to the position, the two positioning rods of the positioning card are retracted and the corresponding positions are attached to the outer wall of the male plug, and the corresponding positions on the two clamping strips are slide along the outer curved surface of the male plug, and move the two clamping strips to the position of the open groove (162) for positioning and clamping, at the same time, the boss abuts against the corresponding position of the limiting block (22) to limit the position; when disassembling, first open the two clamping strips and pull out the locker, and then open the two positioning rods to give way to the boss to pull out the male plug.

With the above structure, the locker is inserted into the housing from the position of the first insertion hole, and the clamping strip is pre-connected to the position of the clamping groove of the positioning block. At this time, insert the positioning card from the position of the second insertion hole, the first oblique sections of the two positioning rods on the positioning card and the limiting block form a hole-like structure for the insertion of the male plug, while the two second oblique sections form a ring-like structure; after inserting the male plug, the boss moves from top to bottom and squeezes the first oblique section and the second oblique section sequentially, so that the two clamping strips and the two positioning rods are opened one after another, after the boss moves down to the position, the two positioning rods of the positioning card are retracted and the corresponding positions are attached to the outer wall of the male plug, and the corresponding positions on the two clamping strips are slide along the outer curved surface of the male plug, and move the two clamping strips to the position of the open groove for positioning and clamping, at the same time, the boss abuts against the corresponding position of the limiting block to limit the position; If the male plug is not installed in place, one case is that when the two positioning rods are in the open state compared with the initial position in the two limiting holes, the positioning card is loose, and the other case is that the boss of the male plug has passed the position of the positioning rod, but the clamping strip and the positioning block have not moved from the pre-clamping position to the clamping positioning position, from the outside of the housing, you can see that the two clamping strips of the locker are opened outward, that is, the locker is loose, and the positions of the two limiting holes are convenient for checking the installation status; when disassembling, first pull out the two clamping strips from the positioning block and pull out the locker, and at the same time move the clamping strips to the pre-clamping position with the positioning block to prevent the locker from slipping, and then open the two positioning rods to give way to the boss to pull out the male plug, the structure is simple and compact, and the whole disassembly process is simple and fast.

In order to better limit the male plug, adapt to the shape of the positioning card and avoid interference, as a preference, an arc groove matching the outer diameter of the male plug is provided on one side of the limiting block (22), and a relief groove (221) is respectively provided on the left and right sides of the notch of the arc groove, and a horizontally protruding protrusion (26) is provided on the outer side of each of the relief grooves (221), each of the protrusions (26) is provided with a relief oblique section (261); a fixing block (27) is provided at the lower end of the limiting block (22), and the fixing block (27) and the limiting block (22) forms a stepped structure with a wide top and a narrow bottom, a limiting groove (271) concentric with the arc groove is provided on the fixing block (27), and a weight-reducing hole (272) is provided on the lower end surface of the fixing block (24).

In order to facilitate adaptation to the corresponding structure of the housing and simplify the structure, as a preference, the first clamping strip (23) and the second clamping strip (24) protruding horizontally are provided on the limiting block (22), the extension lines of the protruding ends of the two clamping strips intersect on the horizontal plane; a first contact block (231) and a first positioning block (232) are sequentially provided on the inner side wall of the first clamping strip (23) along the extending direction, the outer wall of the first clamping strip (23) is provided with a first anti-off block (233), the inner wall of the first contact block (231) is provided with a first groove (234), the upper end of the first contact block (231) is provided with a second oblique section (25); a second contact block (241) and a second positioning block (242) are sequentially provided on the inner side wall of the second clamping strip (24) along the extending direction, and the outer side wall of the second clamping strip (23) is provided with a second anti-off block (243), the inner side wall of the second contact block (241) is provided with a second groove (244), and the upper end of the second contact block (241) is also provided with a second oblique section (25), the locker extends into the first insertion hole (11), and when the first clamping strip (23) and the second clamping strip (24) move to the position of the positioning block (15), the first positioning block (232) and the second positioning block (242) are inserted into the clamping groove (161) at the corresponding ends for pre-clamping.

In order to facilitate production and ensure the consistency of the disassembly state, as a preference, between the first contact block (231) and the second contact block (241), between the first groove (234) and the second grooves (244), between the two second oblique sections (25) and between the first anti-off block (233) and the second anti-off block (243) are arranged symmetrically.

In order to simplify the structure and facilitate production, preferably, the positioning card comprises an arc-shaped plate (3), a first positioning rod (31) and a second positioning rod (32) protruding horizontally are arranged on the upper end of the arc-shaped plate (3), the extension lines of the protruding ends of the two positioning rods intersect on the horizontal plane; a first positioning boss (311) is provide on the first positioning rod (31), one side of the protruding end of the first positioning rod (31) is provided with a first oblique section (33), and the other side is provided with a first extending section (312) protruding obliquely into the first limiting hole (13), and the first extending section (312) fits with the first inclined wall (17) in the first limiting hole (13), and a first plug (313) is provided on one side of the first oblique section (33); a second positioning boss (321) is provided on the second positioning rod (32), and one side of the protruding end of the second positioning rod (32) is also provided with a first oblique section (33), and the other side is provided with a second extending section (322) protruding obliquely into the second limiting hole (14), and the second extending section (322) is connected with the first inclined wall (17) in the second limiting hole (14), and a second plug (323) is provided on one side of the first oblique section (33).

In order to facilitate production and ensure the consistency of disassembly and assembly states, preferably, between the first positioning boss (311) and the first positioning boss (321), between the two first oblique sections (33), between the first extending section (312) and the second extending section (322), and between the first plug (313) and the first insertion block (323) are arranged symmetrically.

In order to avoid skidding during assembly and disassembly, preferably, tooth grooves are provided on the outer surface of the pushing plate (21).

In order to facilitate disassembly, preferably, a notch is provided on the side of the bottom of the cavity structure corresponding to the first insertion hole (11), and a first disassembly groove (41) is formed between the notch and the pushing plate (21), and the first disassembly groove (41) communicates with the weight-reducing hole (272) on the locker; and a second disassembly groove (42) is formed between the side of the bottom of the cavity structure corresponding to the second insertion hole (12) and the arc-shaped plate (3).

In order to make the two positioning rods of the positioning card open quickly when they are disassembled, preferably, guide grooves are provided at the cavity roof of the cavity structure corresponding to the first positioning boss (311) and the second positioning boss (321), and the first positioning boss (311) and the second positioning boss (321) are respectively clamped in the guide grooves at the corresponding ends, and the groove walls on the side of the two guide grooves corresponding to the direction of the first insertion hole (11) are both second inclined walls (18), and the second inclined wall (18) has the same slope as the first inclined wall (17).

Beneficial effects: In the present application, a locker and a positioning card are connected and fixed on the housing, which has a double protection effect on the fixing of the male plug, and is also convenient for observing the installation state, avoiding the occurrence of installation falling off, the structure is simple, and it is easy to disassemble.

### BRIEF DESCRIPTION OF DRAWINGS

FIG. 1 is an exploded diagram of the installation of the present application.

FIG. 2 is a schematic structural diagram of the top of the cavity structure of the housing.

FIG. 3 is a schematic structural diagram of a cavity structure.

FIG. 4 is a schematic structural diagram of the locker.

FIG. 5 is a top view of FIG. 4.

FIG. 6 is a bottom view of FIG. 4.

FIG. 7 is a schematic structural diagram of the positioning card.

FIG. 8 is a top view of FIG. 7.

FIG. 9 is a schematic diagram of the installation process of the present application.

FIG. 10 is a schematic diagram of the installation structure of the present application.

FIG. 11 is a bottom view of FIG. 10.

### DETAILED DESCRIPTION

The application will be further described below in conjunction with the accompanying drawings.

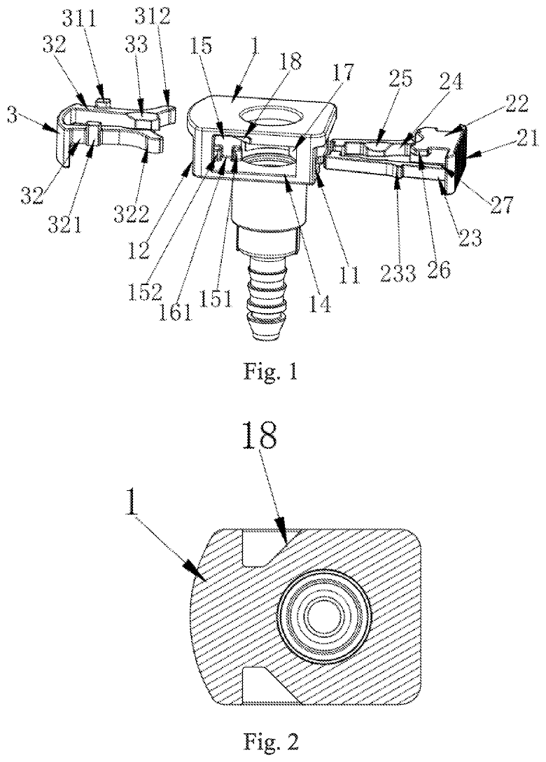

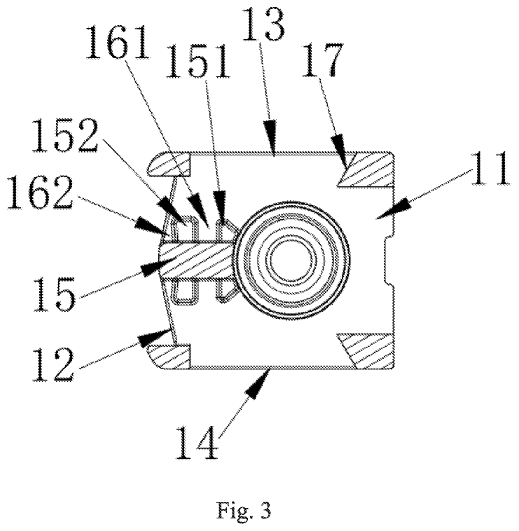

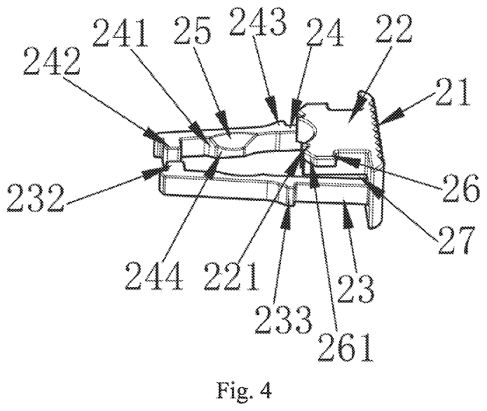

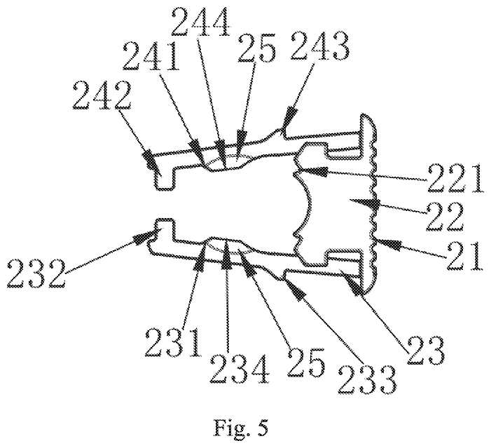

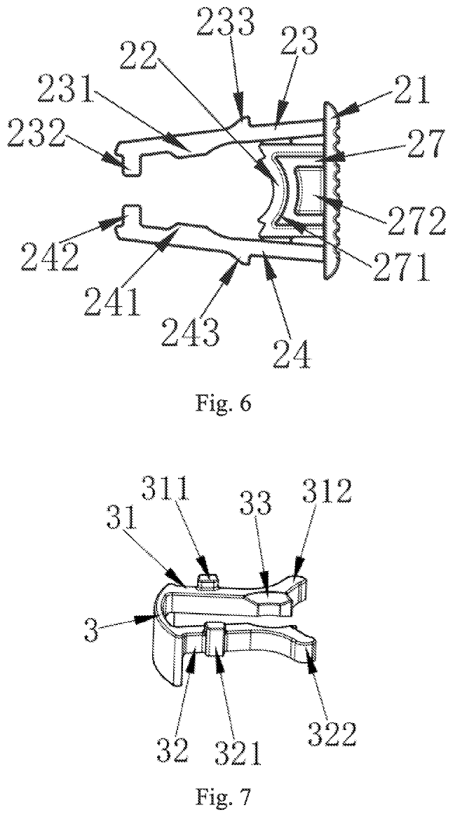

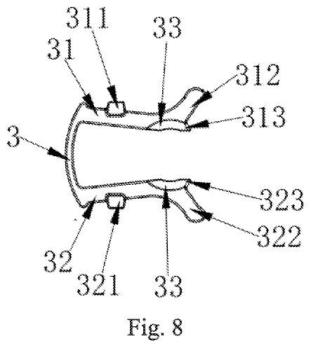

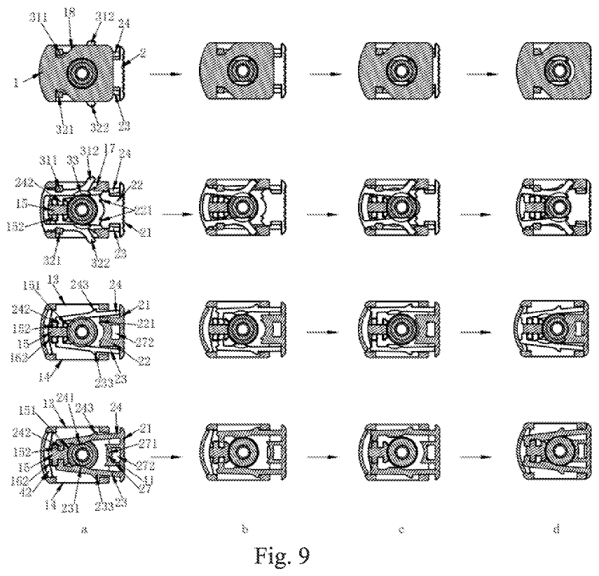

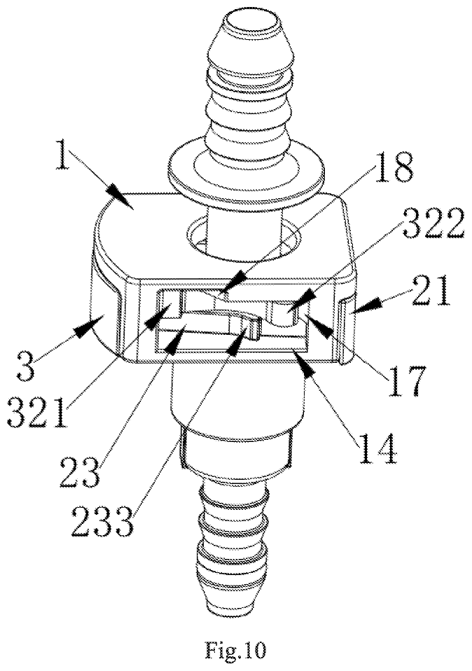

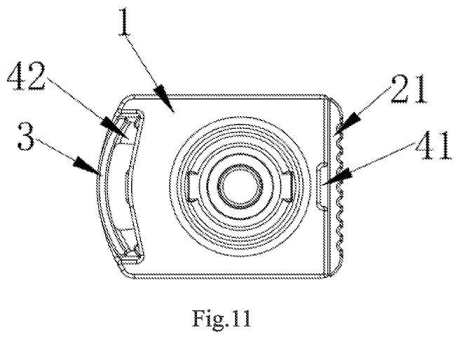

As shown in FIG. 1, FIG. 2, FIG. 3, FIG. 4, FIG. 5, FIG. 6, FIG. 7, FIG. 8, FIG. 9, FIG. 10 and FIG. 11, the application comprises a male plug with a boss (1) and a housing, wherein a cavity structure is provided in the housing (1), and one end of the cavity structure is provided with a first insertion hole (11), the other end is provided with a second insertion hole (12), and a first limiting hole (13) and a second limiting hole (14) communicating with each other are symmetrically provided at the middle position of the corresponding cavity structure of the housing (1), the upper part of the same end hole wall of the two limiting holes is provided with a first inclined wall (17), a positioning block (15) is also provided in the cavity structure, and two first locking blocks (151) and two second locking blocks (152) are symmetrically arranged on the positioning block (15), the corresponding positions of the first locking block (151), the second locking block (152) and the positioning block (15) at the corresponding end form a clamping groove (161), the corresponding positions of the second locking block (152) and the positioning block (15) form an open groove (162).

A locker is inserted into the first insertion hole (11), the locker comprises a pushing plate (21), and the upper end of the pushing plate (21) is provided with a limiting block (22), and the lower end is provided with a first clamping strip (23) and a second clamping strip (24), an arc groove matching the outer diameter of the male plug is provided on one side of the limiting block (22), and a relief groove (221) is respectively provided on the left and right sides of the notch of the arc groove, and a horizontally protruding protrusion (26) is provided on the outer side of each of the relief grooves (221), each of the protrusions (26) is provided with a relief oblique section (261); a fixing block (27) is provided at the lower end of the limiting block (22), and the fixing block (27) and the limiting block (22) forms a stepped structure with a wide top and a narrow bottom, a limiting groove (271) concentric with the arc groove is provided on the fixing block (27), and a weight-reducing hole (272) is provided on the lower end surface of the fixing block (24).

the extension lines of the protruding ends of the two clamping strips intersect on the horizontal plane; a first contact block (231) and a first positioning block (232) are sequentially provided on the inner side wall of the first clamping strip (23) along the extending direction, the outer wall of the first clamping strip (23) is provided with a first anti-off block (233), the inner wall of the first contact block (231) is provided with a first groove (234), the upper end of the first contact block (231) is provided with a second oblique section (25); a second contact block (241) and a second positioning block (242) are sequentially provided on the inner side wall of the second clamping strip (24) along the extending direction, and the outer side wall of the second clamping strip (23) is provided with a second anti-off block (243), the inner side wall of the second contact block (241) is provided with a second groove (244), and the upper end of the second contact block (241) is also provided with a second oblique section (25), the locker extends into the first insertion hole (11), and when the first clamping strip (23) and the second clamping strip (24) move to the position of the positioning block (15), the first positioning block (232) and the second positioning block (242) are inserted into the clamping groove (161) at the corresponding ends for pre-clamping.

Between the first contact block (231) and the second contact block (241), between the first groove (234) and the second grooves (244), between the two second oblique sections (25) and between the first anti-off block (233) and the second anti-off block (243) are arranged symmetrically.

A positioning card is inserted into the second insertion hole (12), the positioning card comprises an arc-shaped plate (3), a first positioning rod (31) and a second positioning rod (32) protruding horizontally are arranged on the upper end of the arc-shaped plate (3), the extension lines of the protruding ends of the two positioning rods intersect on the horizontal plane; a first positioning boss (311) is provide on the first positioning rod (31), one side of the protruding end of the first positioning rod (31) is provided with a first oblique section (33), and the other side is provided with a first extending section (312) protruding obliquely into the first limiting hole (13), and the first extending section (312) fits with the first inclined wall (17) in the first limiting hole (13), and a first plug (313) is provided on one side of the first oblique section (33); a second positioning boss (321) is provided on the second positioning rod (32), and one side of the protruding end of the second positioning rod (32) is also provided with a first oblique section (33), and the other side is provided with a second extending section (322) protruding obliquely into the second limiting hole (14), and the second extending section (322) is connected with the first inclined wall (17) in the second limiting hole (14), and a second plug (323) is provided on one side of the first oblique section (33).

Between the first positioning boss (311) and the first positioning boss (321), between the two first oblique sections (33), between the first extending section (312) and the second extending section (322), and between the first plug (313) and the first insertion block (323) are arranged symmetrically. The positioning card comprises a first positioning rod (31) and a second positioning rod (32), and the first oblique section (33) is provided on each of the two positioning rods.

A notch is provided on the side of the bottom of the cavity structure corresponding to the first insertion hole (11), and a first disassembly groove (41) is formed between the notch and the pushing plate (21), and the first disassembly groove (41) communicates with the weight-reducing hole (272) on the locker; and a second disassembly groove (42) is formed between the side of the bottom of the cavity structure corresponding to the second insertion hole (12) and the arc-shaped plate (3).

Guide grooves are provided at the cavity roof of the cavity structure corresponding to the first positioning boss (311) and the second positioning boss (321), and the first positioning boss (311) and the second positioning boss (321) are respectively clamped in the guide grooves at the corresponding ends, and the groove walls on the side of the two guide grooves corresponding to the direction of the first insertion hole (11) are both second inclined walls (18), and the second inclined wall (18) has the same slope as the first inclined wall (17).

After inserting the male plug, the boss moves from top to bottom and squeezes the first oblique section (33) and the second oblique section (25) sequentially, so that the two clamping strips and the two positioning rods are opened one after another, after the boss moves down to the position, the two positioning rods of the positioning card are retracted and the corresponding positions are attached to the outer wall of the male plug, and the corresponding positions on the two clamping strips are slide along the outer curved surface of the male plug, and move the two clamping strips to the corresponding position of the positioning block (15) for positioning and clamping, at the same time, the boss abuts against the corresponding position of the limiting block (22) to limit the position; when disassembling, first open the two clamping strips and pull out the locker, and then open the two positioning rods to give way to the boss to pull out the male plug.

The using method of the present application is as follows:

As shown in FIGS. 1 to 11, when in use, the locker is inserted into the housing 1 from the position of the first insertion hole 11, and the first clamping strip (23), and when the second clamping strip (24) move to the position of the positioning block (15), the first positioning block (232) and the second positioning block (242) are inserted into the clamping groove (161) at the corresponding end for pre-clamping; At this time, insert the positioning card from the position of the second insertion hole 12, the first extending section (312) extends into the first limiting hole 13, the second extending section (322) extends into the second limiting hole 14, and the first positioning boss (311) and the second positioning boss (321) respectively clamped into the guide groove at the corresponding end, the first oblique sections 31 of the two positioning rods and the limiting block 22 form a hole-like structure for the insertion of the male plug, while the two second oblique sections 25 form a ring-like structure.

As shown in diagrams a to d in FIG. 9, after inserting the male plug, the boss moves from top to bottom and squeezes the first oblique section 33, so that the two positioning rods are simultaneously opened. The first extending section 313 and the second extending section 323 move along the first inclined wall 17 at the corresponding end, while the first positioning boss (311) and the second positioning boss (321) move along the second inclined wall 18 in the guide groove. When the boss moved down to the position of the positioning rod, the two positioning rods moved back. Since the two positioning rods are symmetrically tilted, the inner side wall at the position of the first oblique section 33 forms a slope relative to the outer side wall of the male plug. When the two oblique sections 33 move back to fit with the outer wall of the male plug, the inner wall of the oblique section 33 will form a sliding tendency on the outer wall of the male plug, that is, the positioning card will automatically move into the housing, and it is also convenient for manual pushing to achieve the purpose of accelerated locking. The inner side walls of the two first oblique sections (33) fit the corresponding positions of the outer side walls of the male plug. At this time, a second disassembly groove (42) is formed between the side of the cavity bottom of the cavity structure of the housing 1 corresponding to the second insertion hole (12) and the arc-shaped plate (3).

Then, the male plug continues to move downward, and the boss squeezes the two second oblique sections 25, and makes the two clamping strips open simultaneously, and both the first positioning block (232) and the second positioning block (242) move out of the clamping groove (161) at the corresponding end. When the boss moves down away from the position of the second oblique section 25, the first clamping strip 23 and the second clamping strip 24 move back. Since the two clamping strips are symmetrically inclined, the inner side wall of the second oblique section 25 forms a slope relative to the outer side wall of the male plug. When the two second oblique sections 25 move back to fit with the outer sidewall of the male plug, the inner sidewall of the second oblique section 25 forms a sliding tendency on the outer sidewall of the male plug, that is, the locking device automatically moves into the housing. Since the two positioning blocks have left the clamping groove 161, after the locker moves into the housing, the two positioning blocks move and engage with the open groove 162 at the corresponding end for positioning. At this time, the first plug (313) and the second plug (313) are plugged into the relief grooves (221) at the corresponding ends respectively to limit the position, and the step structure formed by the fixing block (27) and the limiting block (22), with a wide top and a narrow bottom, is just above the boss, and also plays the role of anti-off position. The bottom of the cavity structure of the housing 1 is provided with a notch on the side corresponding to the first insertion hole (11), and the notch and the pushing plate (21) form a first disassembly groove 41 (as shown the corresponding positions shown in FIG. 3, FIG. 6, FIG. 11 and in diagram d in FIG. 9).

If the male plug is not installed in place, one case is that when the two positioning rods are in the open state compared with the initial position in the two limiting holes, the positioning card is loose, and the other case is that the boss of the male plug has passed the position of the positioning rod, but the clamping strip and the positioning block have not moved from the pre-clamping position to the clamping positioning position, from the outside of the housing, you can see that the two clamping strips of the locker are opened outward, that is, the locker is loose, and the positions of the two limiting holes are convenient for checking the installation status.

When disassembling, use an auxiliary tool to open the two clamping strips from the position of the second disassembly groove (42) and pull out the locker, and move to the position where it is pre-engaged with the positioning block, so as to prevent the locker from slipping (as shown in the diagrams from d to a in FIG. 9), and then, open the two positioning rods at the position of the two limiting holes at the same time, the two positioning rods are in an open shape, the positioning card moves inward for a section, and the two extending sections and the two positioning protrusions on the two positioning rods slide along the first inclined wall 17 and the second inclined wall 18 respectively. The male plug can be pulled out by giving way to the boss, the structure is simple and compact, and the whole disassembly process is simple and fast.

In order to ensure the strength of use and the elastic requirements of disassembly and assembly, the locking device and the positioning card are integrally injection-molded by nylon 66, and this material is the prior art, and will not be repeated here.

It should be noted that, in this embodiment, the slope of the second inclined wall 18 is the same as that of the first inclined wall 17 and does not have uniqueness. According to the use requirements and structural settings, the slope setting of the corresponding position should be convenient for disassembly and assembly.

The parts not described in this application are consistent with the prior art, and will not be repeated here.

The above are only the implementation manners of the present application, and are not intended to limit the patent scope of the present application. All equivalent structures made using the contents of the description and drawings of this application, directly or indirectly used in other related technical fields, are also within the scope of patent protection of this application.

What is claimed is:

1. An error-proof double-locking quick connector, comprising a male plug with a boss and a housing (1), wherein a cavity structure is provided in the housing (1), and one end of the cavity structure is provided with a first insertion hole (11), the other end is provided with a second insertion hole (12), and a first limiting hole (13) and a second limiting hole (14) communicating with each other are symmetrically provided at the middle position of the corresponding cavity structure of the housing (1), the upper part of the same end hole wall of the two limiting holes is provided with a first inclined wall (17), a positioning block (15) is also provided in the cavity structure, and two first locking blocks (151) and two second locking blocks (152) are symmetrically arranged on the positioning block (15), the corresponding positions of the first locking block (151), the second locking block (152) and the positioning block (15) at the corresponding end form a clamping groove (161), the corresponding positions of the second locking block (152) and the positioning block (15) form an open groove (162), a locker is inserted into the first insertion hole (11), the locker comprises a pushing plate (21), and the upper end of the pushing plate (21) is provided with a limiting block (22), and the lower end is provided with a first clamping strip (23) and a second clamping strip (24), a second oblique section (25) is provided on each of the two clamping strips, and the corresponding positions of the two clamping strips are pre-engaged with the position of the clamping groove (161); a positioning card is inserted into the second insertion hole (12), and the positioning card comprises a first positioning rod (31) and a second positioning rod (32), each of the two positioning rods is provided with a first oblique section (33); after inserting the male plug, the boss moves from top to bottom and squeezes the first oblique section (33) and the second oblique section (25) sequentially, so that the two clamping strips and the two positioning rods are opened one after another, after the boss moves down to the position, the two positioning rods of the positioning card are retracted and the corresponding positions are attached to the outer wall of the male plug, and the corresponding positions on the two clamping strips are slide along the outer curved surface of the male plug, and move the two clamping strips to the position of the open groove (162) for positioning and clamping, at the same time, the boss abuts against the corresponding position of the limiting block (22) to limit the position; when disassembling, first open the two clamping strips and pull out the locker, and then open the two positioning rods to give way to the boss to pull out the male plug.

2. The error-proof double-locking quick connector according to claim 1, wherein an arc groove matching the outer diameter of the male plug is provided on one side of the limiting block (22), and a relief groove (221) is respectively provided on the left and right sides of the notch of the arc groove, and a horizontally protruding protrusion (26) is provided on the outer side of each of the relief grooves (221), each of the protrusions (26) is provided with a relief oblique section (261); a fixing block (27) is provided at the lower end of the limiting block (22), and the fixing block (27) and the limiting block (22) forms a stepped structure with a wide top and a narrow bottom, a limiting groove (271) concentric with the arc groove is provided on the fixing block (27), and a weight-reducing hole (272) is provided on the lower end surface of the fixing block (24).

3. The error-proof double-locking quick connector according to claim 1, wherein the first clamping strip (23) and the second clamping strip (24) protruding horizontally are provided on the limiting block (22), the extension lines of the protruding ends of the two clamping strips intersect on the horizontal plane; a first contact block (231) and a first positioning block (232) are sequentially provided on the inner side wall of the first clamping strip (23) along the extending direction, the outer wall of the first clamping strip (23) is provided with a first anti-off block (233), the inner wall of the first contact block (231) is provided with a first groove (234), the upper end of the first contact block (231) is provided with a second oblique section (25); a second contact block (241) and a second positioning block (242) are sequentially provided on the inner side wall of the second clamping strip (24) along the extending direction, and the outer side wall of the second clamping strip (23) is provided with a second anti-off block (243), the inner side wall of the second contact block (241) is provided with a second groove (244), and the upper end of the second contact block (241) is also provided with a second oblique section (25), the locker extends into the first insertion hole (11), and when the first clamping strip (23) and the second clamping strip (24) move to the position of the positioning block (15), the first positioning block (232) and the second positioning block (242) are inserted into the clamping groove (161) at the corresponding ends for pre-clamping.

4. The error-proof double-locking quick connector according to claim 3, wherein between the first contact block (231) and the second contact block (241), between the first groove (234) and the second grooves (244), between the two second oblique sections (25) and between the first anti-off block (233) and the second anti-off block (243) are arranged symmetrically.

5. The error-proof double-locking quick connector according to claim 1, wherein the positioning card comprises an arc-shaped plate (3), a first positioning rod (31) and a second positioning rod (32) protruding horizontally are arranged on the upper end of the arc-shaped plate (3), the extension lines of the protruding ends of the two positioning rods intersect on the horizontal plane; a first positioning boss (311) is provide on the first positioning rod (31), one side of the protruding end of the first positioning rod (31) is provided with a first oblique section (33), and the other side is provided with a first extending section (312) protruding obliquely into the first limiting hole (13), and the first extending section (312) fits with the first inclined wall (17) in the first limiting hole (13), and a first plug (313) is provided on one side of the first oblique section (33); a second positioning boss (321) is provided on the second positioning rod (32), and one side of the protruding end of the second positioning rod (32) is also provided with a first oblique section (33), and the other side is provided with a second extending section (322) protruding obliquely into the second limiting hole (14), and the second extending section (322) is connected with the first inclined wall (17) in the second limiting hole (14), and a second plug (323) is provided on one side of the first oblique section (33).

6. The error-proof double-locking quick connector according to claim 5, wherein between the first positioning boss (311) and the first positioning boss (321), between the two first oblique sections (33), between the first extending section (312) and the second extending section (322), and between the first plug (313) and the first insertion block (323) are arranged symmetrically.

7. The error-proof double-locking quick connector according to claim 1, wherein tooth grooves are provided on the outer surface of the pushing plate (21).

8. The error-proof double-locking quick connector according to claim 1, wherein a notch is provided on the side of the bottom of the cavity structure corresponding to the first insertion hole (11), and a first disassembly groove (41) is formed between the notch and the pushing plate (21), and the first disassembly groove (41) communicates with the weight-reducing hole (272) on the locker; and a second disassembly groove (42) is formed between the side of the bottom of the cavity structure corresponding to the second insertion hole (12) and the arc-shaped plate (3).

9. The error-proof double-locking quick connector according to claim 5, wherein guide grooves are provided at the cavity roof of the cavity structure corresponding to the first positioning boss (311) and the second positioning boss (321), and the first positioning boss (311) and the second positioning boss (321) are respectively clamped in the guide grooves at the corresponding ends, and the groove walls on the side of the two guide grooves corresponding to the direction of the first insertion hole (11) are both second inclined walls (18), and the second inclined wall (18) has the same slope as the first inclined wall (17).
